(19) United States
(12) Patent Application Publication
(10) Pub. No.: US 2025/0368250 A1
(43) Pub. Date: Dec. 4, 2025

(54) Baby Carrier with Lockable Wheel Assembly Steering Mechanism

(71) Applicant: SUNNYLOVE BABY PRODUCTS ZHUHAI CO., LTD, Zhuhai City (CN)

(72) Inventors: Xiu Ping LIU, Zhuhai City (CN); Lin SU, Zhuhai City (CN)

(21) Appl. No.: 19/026,665

(22) Filed: Jan. 17, 2025

(30) Foreign Application Priority Data
May 28, 2024 (CN) 2024211947964

(51) Int. Cl. B62B 7/08

(52) U.S. Cl. CPC B62B 7/083; B62B 2205/24

(57) ABSTRACT

A baby carrier includes a carrier body, a support assembly connected to the carrier body and is capable of being folded or unfolded with respect to the carrier body, a a plurality of wheel assemblies, and a wheel assembly locking mechanism provided between at least one of the wheel assemblies and the support assembly, wherein the wheel assembly locking mechanism is triggered during a folding process of the support assembly so that the corresponding wheel assembly is locked with respect to the support assembly.

### CROSS REFERENCE OF RELATED APPLICATION

This application is a non-provisional application that claims priority under 35 U.S.C. § 119 to China application number CN202421194796.4, filing date May 28, 2024, wherein the entire content of which is expressly incorporated herein by reference.

### BACKGROUND OF THE PRESENT INVENTION

### Field of Invention

The present invention relates to the technical field of baby safety travel products, and more particular to a baby carrier with lockable wheel assembly steering mechanism.

### Description of Related Arts

A baby carrier may be a baby stroller or a pushable baby safety seat. When a conventional baby carrier is placed upright, the wheels may rotate with respect to the frame, which may cause the folded baby carrier to tip over or become unstable. In particular, when the baby carrier is temporarily folded for a short period of time, the folded baby carrier cannot be placed upright stably, which may cause many inconveniences.

In addition, some baby carriers have wheel locking mechanisms between the wheels and the frame to lock the wheels from a state where they can rotate around the frame to a state where they cannot rotate around the frame when needed or desired. However, the wheel locking mechanisms of conventional baby carriers usually have the disadvantages of being complex in structure and not being able to automatically orientate; and when folding the baby carrier, it is difficult to orient the front wheels, and the front wheels need to be manually aligned for folding and folding, which is very inconvenient to operate.

### SUMMARY OF THE PRESENT INVENTION

The purpose of the present invention is to overcome the shortcomings of the prior art and provide a baby carrier with a lockable wheel assembly steering mechanism. The wheel assembly locking mechanism is triggered during the folding process of the support assembly so that the corresponding wheel assembly is locked with respect to the support assembly, which can avoid interference between the wheel assembly and other rods of the baby carrier and affect the folding effect, so that the baby carrier can be folded smoothly.

The present invention discloses a baby carrier with a lockable wheel assembly steering mechanism, wherein the baby carrier, which can be moved between an unfolded state and a folded state, comprises:
a carrier body;
a support assembly connected to the carrier body and can be folded or unfolded with respect to the carrier body;
a plurality of wheel assembly connected to the support assembly; and
a wheel assembly locking mechanism provided between at least one of the plurality of wheel assemblies and the support assembly. The wheel assembly locking mechanism is triggered during the folding process of the support assembly so that the corresponding wheel assembly is locked with respect to the support assembly.

The support assembly comprises a front leg rod and a rear leg rod, the upper end of the front leg rod is connected to the carrier body; the upper end of the rear leg rod is connected to the carrier body.

The plurality of wheel assemblies comprises a front wheel assembly which is connected to the lower end of the front leg rod through a pivot, and the front wheel assembly can rotate with respect to the front leg rod around the central axis of the pivot.

The wheel assembly locking mechanism is located between the front leg rod and the front wheel assembly, and the wheel assembly locking mechanism is triggered during the folding process of the support assembly so that the front wheel assembly is locked with respect to the front leg rod to limit the front wheel assembly from rotating around the center axis of the pivot.

In the baby carrier as described above, the wheel assembly locking mechanism is configured to drive the front wheel assembly to rotate to a preset angle with respect to the front leg rod when the support assembly switches from unfolding to folding with respect to the carrier body, and when the front wheel assembly is at the preset angle, the front wheel assembly is locked with respect to the front leg rod.

In the baby carrier as described above, when the wheel locking mechanism locks the front wheel assembly with respect to the front leg rod, the two front wheel assemblies rotate around the center axis of the pivot to be parallel to the side of the carrier body.

In the baby carrier as described above, the support assembly comprises a linkage component located between the front leg rod and the rear leg rod; the wheel assembly locking mechanism is configured to be triggered by the linkage component and actuated when the support assembly switches from an unfolded state to a folded state with respect to the carrier body.

In the baby carrier as described above, when the wheel locking mechanism locks the front wheel assembly with respect to the front leg rod, the front wheel assembly is located at front side of or in front of the carrier body, and the front wheel assembly and the carrier body can simultaneously contact the support plane.

In the baby carrier as described above, wherein the front wheel assembly comprises a front wheel seat rotatably connected to the front leg rod via a pivot and a front wheel arranged on the front wheel seat; the wheel assembly locking mechanism comprises a retaining portion arranged on the front wheel seat, a locking member movably arranged on the front leg rod, a driving member placed between the locking member and the linkage component, and a reset elastic member for driving the locking member to elastically reset, the retaining portion is eccentrically arranged besides the pivot, and the locking member can be inserted to the retaining portion to lock the front wheel seat with respect to the front leg rod.

In the baby carrier as described above, the wheel assembly locking mechanism comprises a retaining portion provided on the front wheel seat, a locking member movably provided on the front leg rod, and a guide bevel provided on the front wheel seat, wherein the retaining portion is located at the bottom of the guide bevel. When the support assembly is folded with respect to the carrier body, the lower end of the locking member slidably contacts the guide bevel, so that the front wheel seat rotates to a preset angle with respect to the front leg rod.

In the baby carrier as described above, the driving member is a rigid rod movably arranged in the front leg rod, and the lower end of the driving member abuts against the upper end of the locking member. The upper end of the driving member can be abutted by the linkage component when the support assembly is folded with respect to the carrier body, so that the lower end of the driving member abuts against the locking member, and the locking member is inserted into the retaining portion to lock the front wheel seat with respect to the front leg rod; and when the support assembly is unfolded with respect to the carrier body, the reset elastic member elastically presses the locking member to disengage from the retaining portion and reset it.

In the baby carrier as described above, the driving member is a flexible rope movably arranged in the front leg rod, the lower end of the driving member is connected to the upper end of the locking member, and the upper end of the driving member is connected to the linkage component. When the support assembly is folded with respect to the carrier body, the linkage component loosens the driving member, and the locking member is inserted into the retaining portion under the elastic resetting action of the reset elastic member to lock the front wheel seat with respect to the front leg rod; and when the support assembly is unfolded with respect to the carrier body, the linkage component pulls the driving member, and the lower end of the driving member pulls the locking member out of the retaining portion to release the locking state of the front wheel seat with respect to the front leg rod.

In the baby carrier as described above, the upper end of the rear leg rod is pivotally connected to the carrier body, and the upper end of the front leg rod is slidably and rotatably connected to the carrier body. One end of the linkage component is pivotally connected to the middle of the rear leg rod, and the other end of the linkage component is extended inclinedly toward the upper end of the front leg rod and is pivotally connected to the upper end of the front leg rod. The linkage component is configured so that when the rear leg rod is folded toward the bottom of the carrier body, the linkage component is linked to the front leg rod to slide upward with respect to the carrier body and fold against the front side of the carrier body.

In the baby carrier as described above, a folding guide groove is provided in the front side of the carrier body, the upper end of the front leg rod is slidably connected to the folding guide groove, and the upper end of the front leg rod can rotate around the first pivot, the linkage component is rotatably connected to the upper end of the front leg rod via the second pivot, and the second pivot is eccentrically arranged with respect to the first pivot, so that the linkage component pushes the front leg rod to slide along the folding guide groove while rotating around the first pivot until the front leg rod is completely folded and pressed against the front side of the carrier body.

Compared with the prior art, the present invention has the following advantages.
1. In the present invention, the wheel assembly locking mechanism is triggered during the folding process of the support assembly so that the corresponding wheel assembly is locked with respect to the support assembly, thereby preventing the wheel assembly from interfering with other rods of the baby carrier and affecting the folding effect, and making the baby carrier fold smoothly.
2. Furthermore, the wheel assembly locking mechanism is triggered during the folding process of the support assembly to lock the front wheel assembly at a preset angle with respect to the front leg rod and limit the rotation of the front wheel assembly around the central axis of the pivot, thereby preventing the front wheel assembly from interfering with other rods of the baby carrier and affecting the folding effect; in addition, it can also prevent the front wheel assembly of the baby carrier in the folded state from rotating and colliding with other rods of the baby carrier, thereby affecting its service life or use effect.
3. During the switching process from unfolding to folding of the support assembly with respect to the carrier body, the wheel assembly locking mechanism drives the front wheel assembly to automatically rotate to a preset angle with respect to the front leg rod, without the need for the user to manually rotate the front wheel assembly to the preset angle, and the folding is convenient.
4. For the convenience of operation, when the support assembly switches from unfolding to folding with respect to the carrier body, the wheel assembly locking mechanism is triggered by the linkage component and operates, which has the characteristics of simple structure and stable and reliable operation.

### BRIEF DESCRIPTION OF THE DRAWINGS

The specific embodiments of the present invention are further described in detail below with reference to the accompanying drawings, wherein:

FIG. 1 is a schematic side view of a baby carrier being in an unfolded state according to a first embodiment of the present invention.

FIG. 2 is a sectional view illustrating a wheel assembly locking mechanism being in an unlocked sate according to the first embodiment of the present invention.

FIG. 3 is a side schematic view of the baby carrier being in a folded state according to the first embodiment of the present invention.

FIG. 4 is another side schematic view of the baby carrier being in a folded state according to the first embodiment of the present invention.

FIG. 5 is a sectional view illustrating a wheel assembly locking mechanism being in a locked sate according to the first embodiment.

FIG. 6 is an exploded view illustrating the wheel assembly locking mechanism according to the first embodiment of the present invention.

FIG. 7 is a side schematic view of the baby carrier being in a folded state according to a second embodiment of the present invention.

### DETAILED DESCRIPTION OF THE PREFERRED EMBODIMENT

The embodiments of the present invention are described in detail below with reference to the accompanying drawings.

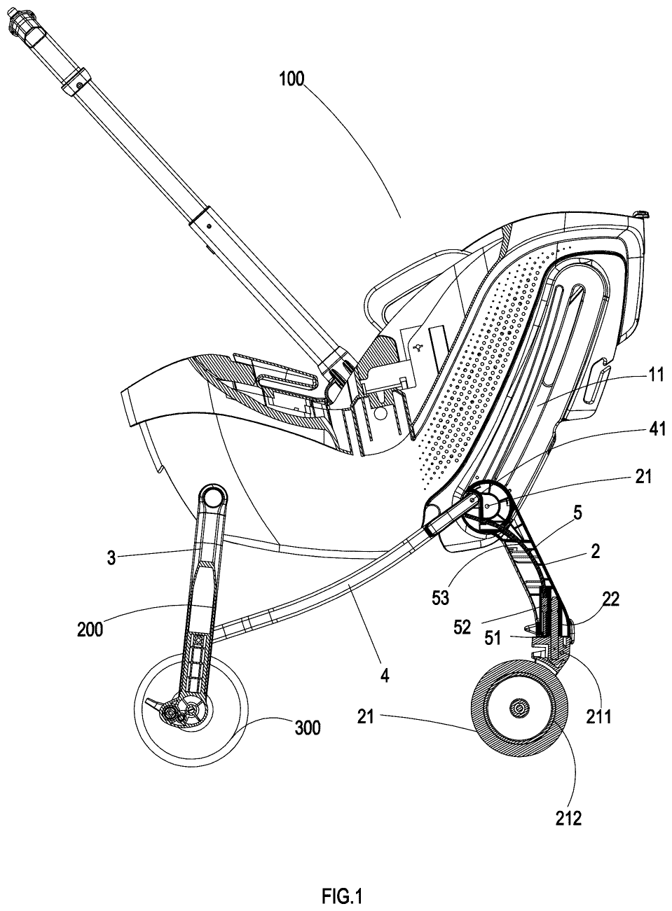

As shown in FIGS. 1-6, a baby carrier with a lockable wheel assembly steering mechanism according to a first embodiment of the present invention is provided, the baby carrier can be moved between an unfolded state and a folded state, and the baby carrier can be a baby stroller, a pushable baby safety seat, or a pushable infant basket. More specifically, the baby carrier comprises a carrier body 100, a support assembly 200, and a plurality of wheel assemblies 300, wherein the support assembly 200 is connected to the carrier body 100 and can be folded or unfolded with respect to the carrier body 100; the wheel assemblies 300 are connected to the support assembly 200; a wheel assembly locking mechanism 5 is provided between at least one of the wheel assemblies and the support assembly 200, the wheel assembly locking mechanism 5 and the wheel assembly 300 are embodied as the lockable wheel assembly steering mechanism of the present invention, and the wheel assembly locking mechanism 5 is triggered during the folding process of the support assembly 200 so that the corresponding wheel assembly is locked with respect to the support assembly 200. In the present invention, the wheel assembly locking mechanism 5 is triggered during the folding process of the support assembly 200 so that the corresponding wheel assembly is locked with respect to the support assembly 200, thereby avoiding interference between the wheel assembly 300 and the other rods of the baby carrier and affecting the folding effect, and making the folding of the baby carrier smooth.

More specifically, the support assembly 200 comprises a front leg rod 2 and a rear leg rod 3, an upper end of the front leg rod 2 is connected to the carrier body 100; an upper end of the rear leg rod 3 is connected to the carrier body 100; the wheel assembly 300 comprises a front wheel assembly 21 which is connected to a lower end of the front leg rod 2 through a pivot 22, the pivot 22 is fixed to the front wheel assembly 21 and is rotatably coupled to the front leg rod 2, so that the front wheel assembly 21 can rotate with respect to the front leg rod 2 through the pivot 22, so as to change direction during the pushing and using process; the wheel assembly locking mechanism 5 is located between the front leg rod 2 and the front wheel assembly 21, and the wheel assembly locking mechanism 5 is triggered during the folding process of the support assembly 200 so that the front wheel assembly 21 is locked with respect to the front leg rod 2 and the front wheel assembly 21 is restricted from rotating around the pivot 22. In this embodiment, the wheel assembly locking mechanism 5 is triggered during the folding process of the support assembly 200 to lock the front wheel assembly 21 at a preset angle with respect to the front leg rod 2 and restrict the front wheel assembly 21 from rotating around the the pivot 22, so as to avoid the front wheel assembly 21 from interfering with the baby carrier body 100 and other rods and affecting the folding effect.

As shown in FIGS. 1, 3, 4, and 7, the upper end of the rear leg rod 3 is pivoted on the carrier body 100, and the upper end of the front leg rod 2 is slidably and rotatably connected to the carrier body 100. One end of a linkage component 4 is pivoted to a middle part of the rear leg rod 3, and the other end of the linkage component 4 is inclinedly extended toward the upper end of the front leg rod 2 and is pivoted to the upper end of the front leg rod 2. The linkage component 4 is configured in a manner that when the rear leg rod 3 is folded toward the bottom of the carrier body 100, the linkage component 4 is linked to the front leg rod 2 to slide upward with respect to the carrier body 100 and fold against the front side of the carrier body 100. A front side of the carrier body 100 is provided with a folding guide groove 11, the upper end of the front leg rod 2 is slidably engaged with the folding guide groove 11, and the upper end of the front leg rod 2 can rotate with respect to a first pivot 21, the linkage component 4 is rotatably connected to the upper end of the front leg rod 2 through a second pivot 41, and the second pivot 41 is eccentrically arranged with respect to the first pivot 21, so that the linkage component 4 pushes the front leg rod 2 to slide along the folding guide groove 11 while rotating around the first pivot 21 until the front leg rod 2 is completely folded and pressed against the front side of the carrier body 100. When the present invention is in the unfolded state, the upper end of the front leg rod 2 slides to a lower end of the folding guide groove 11 and is locked; when the present invention is in the folded state, the upper end of the front leg rod 2 slides to an upper end of the folding guide groove 11.

The specific structure of the baby carrier of the present invention can be found in a baby carrier with China application number CN202222908888.1 submitted by the applicant on Nov. 2, 2022, which will not be repeated here.

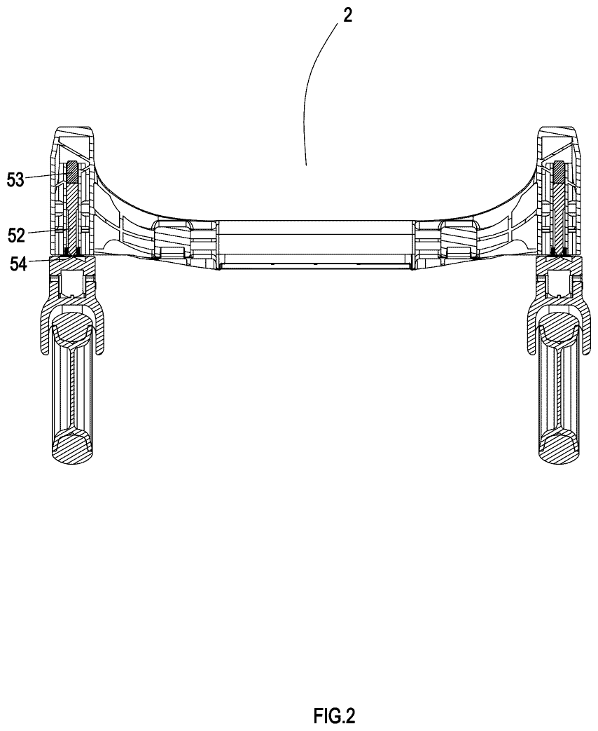

The wheel assembly locking mechanism 5 is configured to drive the front wheel assembly 21 to automatically rotate to a preset angle with respect to the front leg rod 2 when the support assembly 200 switches from unfolding to folding with respect to the carrier body 100, without the need for the user to manually rotate the front wheel assembly 21 to the preset angle. In order to drive the front wheel assembly 21 to rotate to the preset angle accordingly, specifically, as shown in FIGS. 2, 5, and 6, the wheel assembly locking mechanism 5 also comprises a guide bevel 54 provided on a front wheel seat 211, and a retaining portion 51 located at a bottom of the guide bevel 54. When the support assembly 200 is folded with respect to the carrier body 100, a lower end of a locking member 52 slides against the guide bevel 54 to drive the front wheel seat 211 to rotate with respect to the front leg rod 2. In this embodiment, the bottom of the guide bevel 54 is located on a rear part of the front wheel seat 211, as shown in FIG. 1.

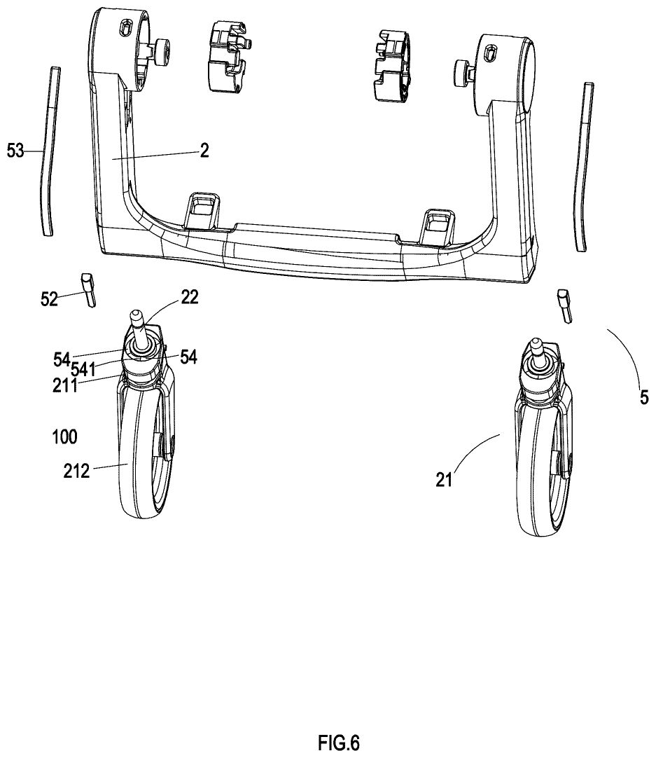

As shown in FIG. 6, two guide bevels 54 are symmetrically arranged on the front wheel seat 211, and the upper ends of the two guide bevels 54 are connected to each other to form a connecting position 541, and the lower ends of the two guide bevels 54 define the retaining portion 51 which can be embodied as a locking groove which is behind the pivot 22, the retaining portion 51 and the connecting position 541 which is the highest position of the guide bevels 54 are at two opposite sides of the pivot 22. Therefore, during the folding process, no matter how the front wheel assembly 21 swings, the symmetrically designed guide bevels 54 can guide the locking member 52 to cooperate with the retaining portion 51, ensuring that the front wheel assembly 21 can smoothly rotate to a preset angle and be locked.

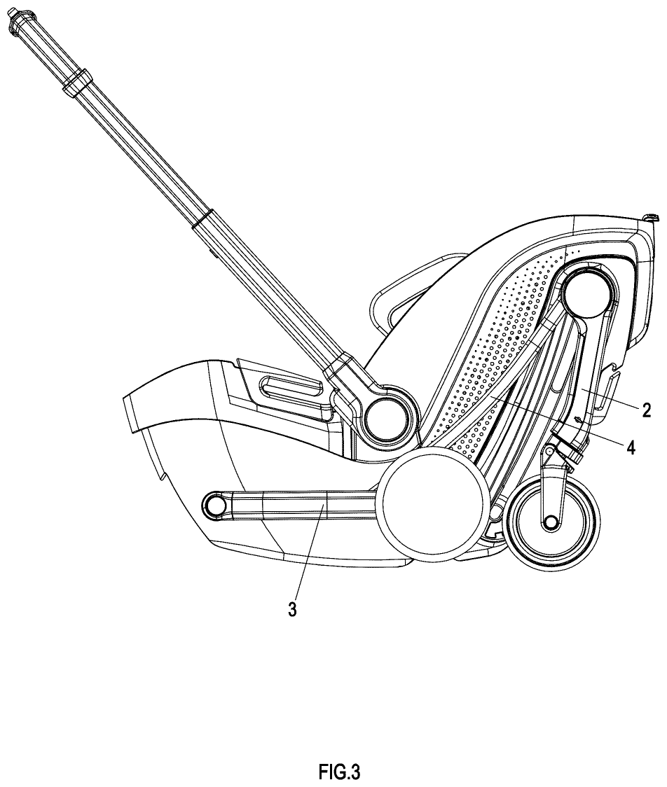

As shown in FIG. 3, in order to make the folding structure more compact and the overall appearance of the baby carrier neatly arranged, when the wheel assembly locking mechanism 5 locks the front wheel assembly 21 with respect to the front leg rod 2, the two front wheel assemblies 21 rotate around the pivot 22 accordingly and become parallel to the side of the carrier body 100, so that the folded structure is more compact, and the front wheel assemblies 21 can avoid shaking due to the rotation around the the pivot 22 after folding.

As shown in FIGS. 1, 3 and 4, for the convenience of operation, the support assembly 200 comprises the linkage component 4 located between the front leg rod 2 and the rear leg rod 3; the wheel assembly locking mechanism 5 is configured to be triggered by the linkage component 4 and actuated when the support assembly 200 switches from the unfolded state to the folded state with respect to the carrier body 100.

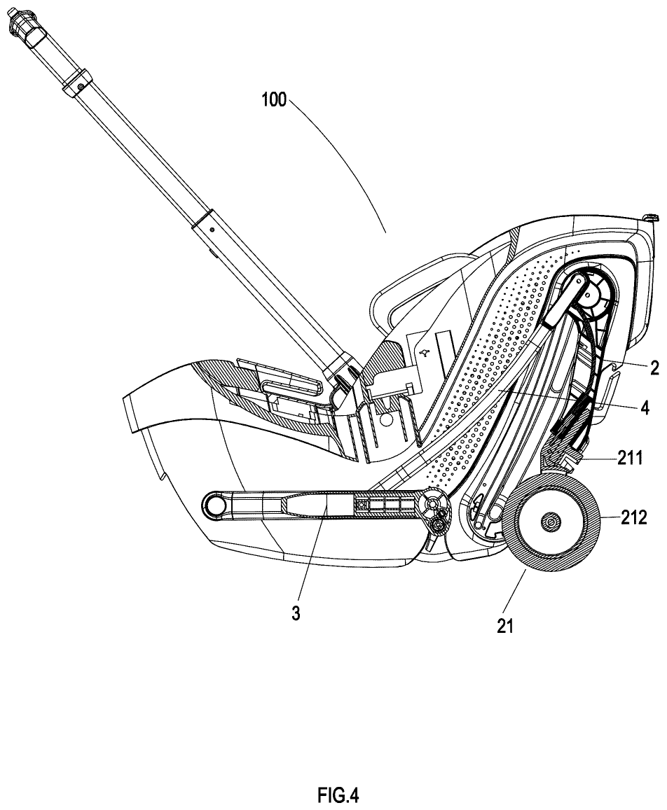

As shown in FIGS. 3 and 4, in order to ensure that the baby carrier is placed in a standing position stably and reliably after being folded, when the wheel assembly locking mechanism 5 locks the front wheel assembly 21 with respect to the front leg rod 2, the front wheel assembly 21 is located at the front side or in front of the carrier body 100, and the front wheel assembly 21 can contact a support plane at the same time as the carrier body 100. As shown in FIGS. 3 and 4, when the baby carrier is folded and placed in a standing position, the bottom of the carrier body 100 and the bottom sides of the two front wheel assemblies 21 are respectively standing against the support plane, thereby forming a three-point support shape, ensuring that the baby carrier stands stably and reliably, and avoiding the baby carrier from standing unsteadily and tilting, rolling over, etc.

This embodiment also comprises but is not limited to a retractable or rotatable handle connected to the carrier body 100. When the baby carrier is in the folded state, the user can directly pull up the handle to make the front wheel assemblies 21 contact the ground alone to roll and drag the baby carrier. At this time, the bottom of the carrier body 100 is separated from the support surface, which increases the diversity and applicability of use in different occasions.

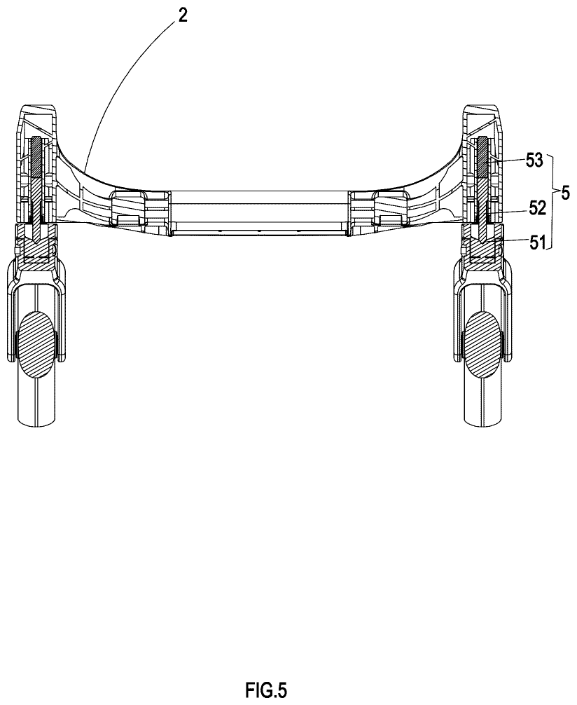

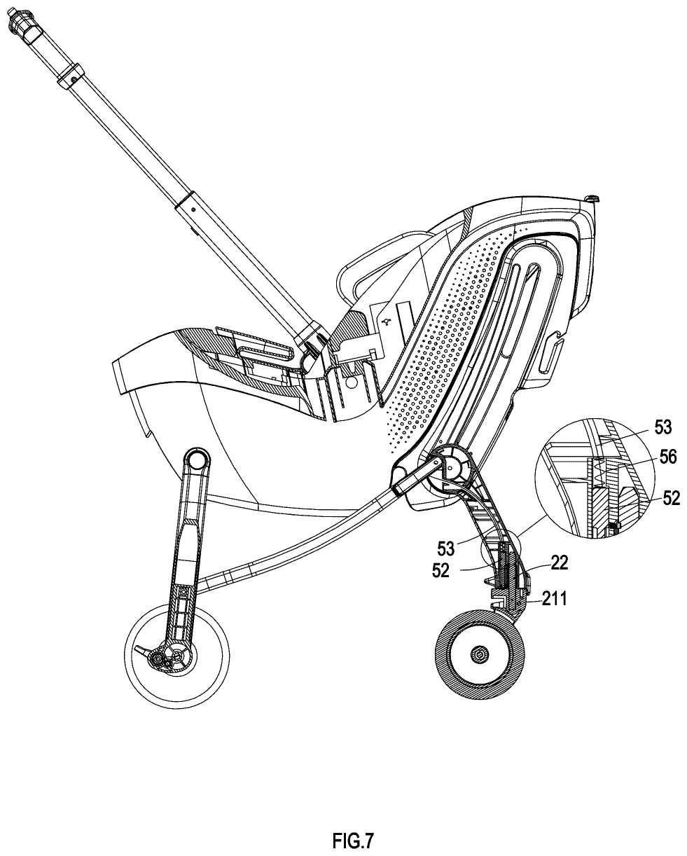

As shown in FIGS. 2, 5 and 5, and also with reference to FIG. 7 in which a reset elastic member 56 is illustrated, in order to ensure reliable locking and convenient resetting, the front wheel assembly 21 comprises the front wheel seat 211 rotatably connected to the front leg rod 2 through a pivot and a front wheel 212 arranged on the front wheel seat 211; the wheel assembly locking mechanism 5 comprises the retaining portion 51 arranged on the front wheel seat 211, the locking member 52 movably arranged on the front leg rod 2, a driving member 53 placed between the locking member 52 and the linkage component 4, and the reset elastic member 56 for driving the locking member 52 to resiliently reposition, the retaining portion 51 is eccentrically arranged on the front wheel seat 211 and is deviated from the central pivot 22, and the locking member 52 can be inserted into the retaining portion 51 to lock the front wheel seat 211 with respect to the front leg rod 2. The reset elastic member 56 adopts a tension spring or a compression spring according to the different setting positions. In this embodiment, the locking member 52 is a plug-in rod, and the retaining portion 51 is a plug-in groove or a plug-in hole plugged with the plug-in rod.

As shown in FIGS. 1 and 4, for the convenience of operation, the driving member 53 is a rigid rod movably arranged in the front leg rod 2, and a lower end of the driving member 53 abuts against an upper end of the locking member 52. An upper end of the driving member 53 can be abutted by the linkage component 4 when the support assembly 200 is folded with respect to the carrier body 100, so that the lower end of the driving member 53 abuts against the locking member 52, and the locking member 52 is inserted into the retaining portion 51 to lock the front wheel seat 211 with respect to the front leg rod 2; and when the support assembly 200 is unfolded with respect to the carrier body 100, the reset elastic member 56 elastically presses or elastically pulls the locking member 52 away from the retaining portion 51 and resets. The driving member 53 is a rigid rod, which is conducive to improving the linkage response effect between the linkage component 4 and the locking member 52, while ensuring that the realized function is stable and reliable.

As shown in FIGS. 1 and 4, the linkage component 4 is a linkage rod, the front upper end of which is eccentrically rotatably connected to the upper end of the front leg rod 2, the lower end of the linkage rod is rotatably connected to the rear leg rod 3, and the upper end of the front leg rod 2 is provided with a movable space for the linkage rod to rotate. The upper end of the driving member 53 is extended into the movable space and is resisted by the linkage component 4 when the supporting assembly is folded with respect to the carrier body 100.

The folding principle of the first embodiment is as follows. When the baby carrier switches from the unfolded state to the folded state, the linkage component 4 presses the driving member 53 to slide downward with respect to the front leg rod 2, and the lower end of the driving member 53 pushes the upper end of the locking member 52 to make the locking member 52 slide downward with respect to the front leg rod 2. The lower end of the locking member 52 cooperates with the corresponding guide bevels 54 to drive the front wheel assembly 21 to rotate around the pivot 22 to a preset angle. When the front wheel assembly 21 rotates to the preset angle, the lower end of the locking member 52 is inserted into the retaining portion 51 to lock the front wheel assembly 21 with respect to the front leg rod 2, as shown in FIG. 5.

The unfolding principle of the first embodiment is as follows. When the baby carrier switches from the folded state to the unfolded state, the linkage component 4 gradually cancels the force applied to the driving member 53. At this moment, the driving member 53 and the locking member 52 slide upward with respect to the front leg rod 2 under the elastic force of the reset elastic member 56 until the lower end of the locking member 52 is separated from the retaining portion 51 and the guide bevels 54, thereby releasing the locking state of the front wheel assembly with respect to the front leg rod.

As shown in FIG. 7, a second embodiment of the present invention is illustrated. The difference between the second embodiment and the first embodiment lies in that, as shown in FIG. 7, the driving member 53 is a flexible rope such as a wire rope movably arranged in the front leg rod 2, the lower end of the driving member 53 is connected to the upper end of the locking member 52, and the upper end of the driving member 53 is connected to the linkage component 4. When the support assembly 200 is folded with respect to the carrier body 100, the linkage component 4 loosens the driving member 53, and the locking member 52 is inserted into the retaining portion 51 under the elastic resetting action of the reset elastic member 56 to lock the front wheel seat 211 with respect to the front leg rod 2; and when the support assembly 200 is unfolded with respect to the carrier body 100, the linkage component 4 pulls the driving member 53, and the lower end of the driving member 53 pulls the locking member 52 out of the retaining portion 51 to release the locking state of the front wheel seat 211 with respect to the front leg rod 2.

Folding principle of the second embodiment is as follows. When the baby carrier is moved from the unfolded state to the folded state, the linkage component 4 loosens the driving member 53, and the locking member 52 slides downward with respect to the front leg rod 2 under the elastic force of the reset elastic member 56, and the lower end of the locking member 52 cooperates with the corresponding guide bevels 54 to drive the front wheel assembly 21 to rotate to a preset angle around the the pivot 22. When the front wheel assembly 21 rotates to the preset angle, the lower end of the locking member 52 is inserted into the retaining portion 51 to lock the front wheel assembly 21 with respect to the front leg rod 2.

The unfolding principle of the second embodiment is as follows. When the baby carrier switches from the folded state to the unfolded state, the linkage component 4 pulls the locking member 52 to slide upward with respect to the front leg rod 2 through the flexible rope, so that the lower end of the locking member 52 is separated from the retaining portion 51 and the corresponding guide bevels 54, thereby releasing the locking state of the front wheel assembly 21 with respect to the front leg rod 2.

What is claimed is:

1. A baby carrier which is capable of being moved between an unfolded state and a folded state, comprising:
a carrier body;
a support assembly connected to the carrier body and is capable of being folded or unfolded with respect to the carrier body;
a plurality of wheel assemblies connected to the support assembly; and
a wheel assembly locking mechanism provided between at least one of the wheel assemblies and the support assembly, wherein the wheel assembly locking mechanism is triggered during a folding process of the support assembly so that the corresponding wheel assembly is locked with respect to the support assembly.

2. The baby carrier according to claim 1, wherein the support assembly comprises a front leg rod and a rear leg rod, an upper end of the front leg rod is connected to the carrier body, and an upper end of the rear leg rod is connected to the carrier body.

3. The baby carrier according to claim 2, wherein the plurality of wheel assemblies of the wheel assembly comprises a front wheel assembly which is connected to a lower end of the front leg rod and a pivot which is connected to the front wheel assembly and is rotatably coupled with the front leg rod to allow the front wheel assembly to rotate with respect to the front leg rod around the pivot.

4. The baby carrier according to claim 3, wherein the wheel assembly locking mechanism is located between the front leg rod and the front wheel assembly, and the wheel assembly locking mechanism is triggered during the folding process of the support assembly so that the front wheel assembly is locked with respect to the front leg rod to limit the front wheel assembly from rotating around the pivot.

5. The baby carrier according to claim 4, wherein the wheel assembly locking mechanism is configured to drive the front wheel assembly to rotate to a preset angle with respect to the front leg rod when the support assembly switches from the unfolded state to the folded state, and when the front wheel assembly is at the preset angle, the front wheel assembly is locked with respect to the front leg rod.

6. The baby carrier according to claim 5, wherein when the wheel locking mechanism locks the front wheel assembly with respect to the front leg rod, the two front wheel assemblies rotate around the pivot to be parallel to a side of the carrier body.

7. The baby carrier according to claim 3, wherein the support assembly comprises a linkage component located between the front leg rod and the rear leg rod, the wheel assembly locking mechanism is configured to be triggered by the linkage component and actuated when the support assembly switches from the unfolded state to the folded state.

8. The baby carrier according to claim 3, wherein when the wheel locking mechanism locks the front wheel assembly with respect to the front leg rod, the front wheel is located in front of the carrier body.

9. The baby carrier according to claim 7, wherein the front wheel assembly comprises a front wheel seat rotatably connected to the front leg rod via the pivot and a front wheel arranged on the front wheel seat, the wheel assembly locking mechanism comprises a retaining portion arranged on the front wheel seat, a locking member movably arranged on the front leg rod, a driving member placed between the locking member and the linkage component, and a reset elastic member for driving the locking member to elastically reset, the retaining portion is eccentrically arranged on the front wheel seat adjacent to the pivot which is located at a center of the front wheel seat, and the locking member is capable of being inserted to the retaining portion to lock the front wheel seat with respect to the front leg rod.

10. The baby carrier according to claim 9, wherein the retaining portion is a retaining groove for engaging with the locking member.

11. The baby carrier according to claim 7, wherein the wheel assembly locking mechanism comprises a retaining portion provided on the front wheel seat, a locking member movably provided on the front leg rod, and a guide bevel provided on the front wheel seat, wherein the retaining portion is located at a bottom of the guide bevel, wherein when the support assembly is folded with respect to the carrier body, the lower end of the locking member slidably contacts the guide bevel until being inserted into the retaining portion.

12. The baby carrier according to claim 11, wherein the retaining portion is a retaining groove for engaging with the locking member.

13. The baby carrier according to claim 12, wherein two guide bevels are provided on the front wheel seat, and upper ends of the two guide bevels are connected to to form a connecting position, wherein the retaining portion is formed between lower ends of the two guide bevels.

14. The baby carrier according to claim 13, wherein the connection position of the upper ends of the two guide bevels and the retaining portion are formed at two opposite sides of the pivot.

15. The baby carrier according to claim 14, wherein the front wheel assembly comprises a reset elastic member for driving the locking member to elastically reset.

16. The baby carrier according to claim 15, wherein the driving member is a rigid rod movably arranged in the front leg rod, the locking member is inserted into the retaining portion to lock the front wheel seat with respect to the front leg rod; and when the support assembly is unfolded with respect to the carrier body, the reset elastic member elastically presses the locking member to disengage from the retaining portion.

17. The baby carrier according to claim 15, wherein the driving member is a flexible rope movably arranged in the front leg rod, a lower end of the driving member is connected to an upper end of the locking member, and the upper end of the driving member is connected to the linkage component.

18. The baby carrier according to claim 7, wherein an upper end of the rear leg rod is pivotally connected to the carrier body, and an upper end of the front leg rod is slidably and rotatably connected to the carrier body, wherein one end of the linkage component is pivotally connected to a middle of the rear leg rod, and the other end of the linkage component is extended inclinedly toward the upper end of the front leg rod and is pivotally connected to the upper end of the front leg rod, wherein the linkage component is configured so that when the rear leg rod is folded toward a bottom of the carrier body, the linkage component is linked to the front leg rod to slide upward with respect to the carrier body and fold against a front side of the carrier body.

19. The baby carrier according to claim 15, wherein an upper end of the rear leg rod is pivotally connected to the carrier body, and an upper end of the front leg rod is slidably and rotatably connected to the carrier body, wherein one end of the linkage component is pivotally connected to a middle of the rear leg rod, and the other end of the linkage component is extended inclinedly toward the upper end of the front leg rod and is pivotally connected to the upper end of the front leg rod, wherein the linkage component is configured so that when the rear leg rod is folded toward a bottom of the carrier body, the linkage component is linked to the front leg rod to slide upward with respect to the carrier body and fold against a front side of the carrier body.

20. The baby carrier according to claim 19, further comprising a first pivot and a second pivot, wherein a folding guide groove is provided in the front side of the carrier body, the upper end of the front leg rod is slidably engaged with the folding guide groove, and the upper end of the front leg rod is capable of rotating around a first pivot, the linkage component is rotatably connected to the upper end of the front leg rod via the second pivot, and the second pivot is eccentrically arranged with respect to the first pivot, so that the linkage component pushes the front leg rod to slide along the folding guide groove while rotating around the first pivot until the front leg rod is completely folded and pressed against the front side of the carrier body when the baby carrier is moved from the unfolded state the folded state.
